(19) United States
(12) Patent Application Publication
(10) Pub. No.: US 2014/0216993 A1
(43) Pub. Date: Aug. 7, 2014

(54) SINGLE CONTAINER GRAVITY-FED STORAGE WATER PURIFIER

(71) Applicants: Thalappil Pradeep, Chennai (IN); Amrita Chaudhary, Varanasi (IN); Mohan Udhaya Sankar, Cuddalore (IN); Aanshup, Lucknow (IN)

(72) Inventors: Thalappil Pradeep, Chennai (IN); Amrita Chaudhary, Varanasi (IN); Mohan Udhaya Sankar, Cuddalore (IN); Aanshup, Lucknow (IN)

(73) Assignee: INDIAN INSTITUTE OF TECHNOLOGY, Chennai (IN)

(21) Appl. No.: 14/115,591

(22) PCT Filed: Jun. 22, 2012
(86) PCT No.: PCT/IB2012/001237

§ 371 Date: Dec. 2, 2013

(30) Foreign Application Priority Data
May 2, 2011 (IN) 1522/CHE/2011

(51) Int. Cl. B01D 29/00; B01D 29/60; B01D 15/10

(52) U.S. Cl. CPC B01D 29/00; B01D 15/10; B01D 29/60
USPC 210/85; 210/435; 210/295; 210/123

(57) ABSTRACT

A gravity-fed storage water purifier is provided. The gravity-fed water purifier includes a filtration unit for receiving water. The filtration unit includes a housing unit, a first membrane cloth layer, a second membrane cloth layer, and a granular biocidal composition layer disposed between the first and second membrane cloth layers. The first and second membrane cloth layers remove dirt, sand and sediments from the contaminated water, using a depth filtration mechanism. The granular biocidal composition layer removes bacteria and virus from the contaminated water, through fast leaching of silver ions into the water. A single storage container is provided that collects the water filtered by the virtue of filtration unit and gravity. An adsorbent composition is disposed between the storage container and an outlet tap of the storage container.

### CROSS-REFERENCE TO RELATED APPLICATIONS

This Application claims the benefit of Indian Application No. 1522/CHE/2011, filed on May 2, 2011, which is incorporated herein by reference in its entirety.

### BACKGROUND

1. Technical Field

The present disclosure relates to the field of water purification and specifically to a gravity fed storage water purifier.

2. Technical Background

Widespread availability of clean drinking water is a major initiative for governments across the world, especially in the developing and under-developed countries. Technologically, providing clean drinking water involves the removal of a number of contaminants, including biological (e.g. bacteria and virus), inorganic (e.g. fluoride, arsenic, iron) and organic (e.g. pesticides, volatile organics) species from drinking water. However, certain groups of people across the world continue to bear the burden of disease-related expenditures since they cannot afford clean water required for daily routine. This is despite the fact that a number of water purification techniques are available to address the health concerns.

Amongst various known water purification techniques, the oldest one includes use of gravity filtration. For centuries, people used a cloth for the removal of visible dirt and sediments from contaminated water. Even today, people still continue to use this technique (e.g., Reduction of cholera in Bangladeshi villages by simple filtration, Colwell et. al., PNAS, 2003, 100, 1051-1055). The physical filtration techniques have evolved with the use of various other filtration media, e.g., sand filtration (Elimination of viruses, bacteria and protozoan oocysts by slow sand filtration, Hijnen et. al., Water Sci Technol., 2004, 50(1), 147-54), woven and non-woven membrane cloth filtration (Handbook of nonwoven filter media, I. M. Hutten, Elsevier, 2007) and ultrafiltration membranes (Membranes in clean technologies: Theory and practice, Volume 1, Koltuniewicz et. al., Wiley-VCH, 2008).

A major advantage of gravity filtration techniques for microorganism removal is the low cost of water purification. However, with low cost of water purification, complete removal of microorganisms is not ensured since the gravity filtration technique performs water filtration for higher rates of flow of water. Therefore, to achieve better filtration, the rate of flow of water should be extremely low.

Recently, a technique, referred to as ‘gravity-fed storage water purifier’ has gained strong consumer attraction owing to its low cost of manufacturing and operation, zero electricity consumption, no requirement of running water for operation and effective removal of microorganisms from drinking water.

FIG. 1 illustrates a conventional gravity-fed storage water purifier. The conventional gravity-fed storage water purifier 100 includes first and second containers 102 and 104. The first container 102 stores unpurified water, such as contaminated water, and the second container 104 stores purified water. A wall 106 separates the two containers to prevent mixing of unpurified water, such as contaminated water, and purified water. One or more water purification (porous) cartridges 108 are usually positioned between the first and second containers 102 and 104. In a typical use, the contaminated water is poured in the first container 102. The pressure due to the water head in the first container drives the contaminated water into the second container 104 by way of the porous cartridges 108. Typically, during the passage of water through the porous cartridges 108, contaminants in the water are contacted with an adsorbent composition in porous cartridges 108 and are removed from the water.

Gravity-fed storage water purifier cartridges can typically be characterized in two segments: ceramic candle and carbon block based water purification cartridges. A typical ceramic candle based water purifier operates at a flow rate of 1-2 liters/hour (i.e., 10 liters of purified drinking water is made available in 5-10 hours). The fine pores in the ceramic candle remove fine dirt particles from the unpurified water, such as contaminated water. As reported by Bridges et al. in Published US patent application 2008/0202992, which is incorporated herein by reference in its entirety, a biocidal composition can be packed inside a hollow region of the ceramic candle for ensuring that the output water is microbiologically safe for consumption. Similarly, Oyanedel-Craver et al. in Sustainable Colloidal-Silver-Impregnated Ceramic Filter for Point-of-Use Water, Environ. Sci. Technol. 2008, 42, 927-933 have shown that silver nanoparticles impregnated ceramic filters can remove bacteria from drinking water.

A typical carbon block based water purifier operates at a flow rate of 3-6 liters/hour (i.e., 10 liters of purified drinking water is made available in 2-3 hours). The carbon block is utilized for the removal of reactive chlorine and trace organics from the unpurified water, such as contaminated water. As reported by Bommi et al. in U.S. Pat. No. 7,585,409 and Mistry et al. in PCT published application WO/2004/000732, which both are incorporated herein by reference in their entirety for the purpose of disclosing water purification methods and techniques, biocidal compositions can either be mixed in the carbon block or can be placed at the bottom of the carbon block.

Despite various efforts to tackle microbiological contamination by using a number of filtration media and through several modifications in water purifier designs, the costs of these solutions still remain relatively high. Affordability of purifiers is an important factor in increasing peoples' access to clean drinking water. A low cost of ownership for household-based water purifier is likely to play a major role in improving the health of citizens worldwide. It is estimated that the container cost is ˜30% of the price of the water purifier, as about 2-3 kg of plastic is used per purifier to make a typical container. Moreover, two containers contribute to additional cost of manufacturing the device. Different variations of the two-container gravity-fed storage water purifiers have been reported (e.g., Indian patent application 1571/MUM/2008 by Adroja et al., PCT published application, PCT published application 2004/000732 by Mistry et al., U.S. Pat. No. 5,928,506 by Bae et al., PCT published application, PCT published application 2008/106276 by Bridges et al., and U.S. Pat. No. 2,372,340 by Frank Senyal), which are all incorporated herein by reference in their entirety. The basic design of the two-container gravity-fed storage water purifiers, as explained in conjunction with FIG. 1, has been modified by changing a number of design parameters, including direction of water flow (upwards/downwards), inclusion of flow control valves to prevent overflow, additional flow length for water to increase contact time, and so forth. Such gravity fed storage water purifiers have also been modified in size shape, e.g., carafe type water purifiers; with the top container having a capacity of less than 3 liters.

Another disadvantage associated with storage type water purifiers is the large amount of plastic required (e.g., for two or more containers and cartridge housing). Therefore, it is important to reduce the quantity of plastics used in water purifiers, from the perspective of reducing the cost to the consumer as well as decreasing the environmental damage due to the impact of plastics. Also, regular maintenance of such storage type water purifiers consumes more time since the storage type water purifiers have complicated structure and require multiple parts to be removed, cleaned and re-integrated.

In light of the foregoing, there exists a need to provide a water purifier that addresses the aforementioned problems and other shortcomings associated with the prior art water purification systems.

### SUMMARY

An object of the present invention is to provide a single container gravity-fed storage water purifier that is simple in design, reduces the amount of plastic required for the construction, contains fewer parts for product assembly and entails low cost manufacturing.

Another object of the present invention is to provide a water purifier that can be easily adapted for use in any water purification system, including household, community and industrial systems.

Yet another object of the present invention is to provide a water purifier that delivers microbiologically safe water, such that the concentration of anti-microbial agent in the water is maintained well below WHO (World Health Organization) limits.

In one aspect, a gravity-fed storage water purifier is provided. The gravity-fed water purifier includes a filtration unit for receiving water, such as, for example, contaminated water. The filtration unit includes a first membrane cloth layer, a second membrane cloth layer, and a granular biocidal composition layer disposed between the first and second membrane cloth layers. A single storage container is provided that collects the water filtered by the virtue of filtration unit and gravity.

In another aspect, a gravity-fed storage water purifier is provided. The gravity-fed water purifier includes a filtration unit for receiving water, such as unpurified water or contaminated water. The filtration unit includes a first membrane cloth layer, a second membrane cloth layer, and a biocidal (e.g. granular) composition layer disposed between the first and second membrane cloth layers. The first and second membrane cloth layers can remove dirt, sand and sediments from the water, such as contaminated water, using a depth filtration mechanism. The granular biocidal composition layer can eliminate or remove microbes, such as bacteria and viruses, from the contaminated water, through fast leaching of one or more antimicrobial agents, for example silver ions, into the water. A single storage container is provided that collects the water filtered by the virtue of filtration unit and gravity. An adsorbent composition can be disposed between the storage container and an outlet tap of the storage container.

In another aspect, a filtration unit comprising a first membrane cloth layer, a second membrane cloth layer, and a granular biocidal composition layer disposed between the first and second membrane cloth layers is used as a stand-alone water purification unit. In one aspect, this stand-alone water purification unit can be integrated with any commercially available water purifier. According to this aspect, unpurified water, such as contaminated water, can pass through the stand-alone water purification unit before going to the water purifier. The stand-alone water purification unit can be used by integrating with the existing water purifiers. In an aspect, this stand-alone water purification unit can be used by integrating with a container already available with the consumer. In such an aspect, water, such as contaminated water, is passed through the stand-alone water purification unit and collected in the container available with the consumer.

In one aspect, the granular biocidal composition layer can comprise silver nanoparticles impregnated on, for example, an organic-templated boehmite nanoarchitecture (the composition and its use for water purification is described in the PCT application PCT/IB2011/001551 by the same inventors hereof). In various other aspects, the granular biocidal composition layer comprises silver nanoparticles impregnated on at least one of a polyurethane, an oxide, and/or an oxyhydroxide of at least one of aluminum, zinc, manganese, copper, iron, titanium, zirconium, lanthanum, cerium, and silicon. In another aspect, the granular biocidal composition can comprise silver nanoparticles impregnated on activated carbon and/or on additional silver nanoparticles that can be impregnated on activated carbon.

Additional aspects and advantages of the invention will be set forth, in part, in the detailed description and any claims which follow, and in part will be derived from the detailed description or can be learned by practice of the invention. The advantages described below will be realized and attained by means of the elements and combinations particularly pointed out in the appended claims. It is to be understood that both the foregoing general description and the following detailed description are exemplary and explanatory only and are not restrictive of the invention as disclosed.

### BRIEF DESCRIPTION OF THE FIGURES

The accompanying figures, which are incorporated in and constitute a part of this specification, illustrate several aspects and together with the description serve to explain the principles of the invention.

FIG. 1 depicts a conventional gravity-fed storage water purifier.

FIG. 2 depicts a single container gravity-fed storage water purifier, in accordance with an aspect of the present invention.

FIG. 3 depicts a single container gravity-fed storage water purifier, in accordance with another aspect of the present invention.

FIG. 4 depicts a single container gravity-fed storage water purifier, in accordance with another aspect of the present invention.

FIG. 5 depicts a single container gravity-fed storage water purifier, in accordance with yet another aspect of the present invention.

FIG. 6 depicts top views of a single container gravity-fed storage water purifier with and without a cap, in accordance with various aspects of the present invention.

FIG. 7 depicts (a) filtration unit as a stand-alone water purification unit (b) filtration unit used with a carafe as the storage container, in accordance with various aspects of the present invention.

FIG. 8 depicts filtration unit integrated with commercially available water purifiers such as (a) activated carbon block based water purifier (b) ceramic candle based water purifier (c) membrane (reverse osmosis/ultrafiltration) based water purifier, in accordance with various aspects of the present invention.

FIG. 9 depicts a plot between the volume of water passed through the single container gravity-fed water purifier and corresponding bacterial count, in accordance with various aspects of the present invention.

FIG. 10 depicts a plot between volume of water passed through the single container gravity-fed water purifier and corresponding virus count, in accordance with various aspects of the present invention.

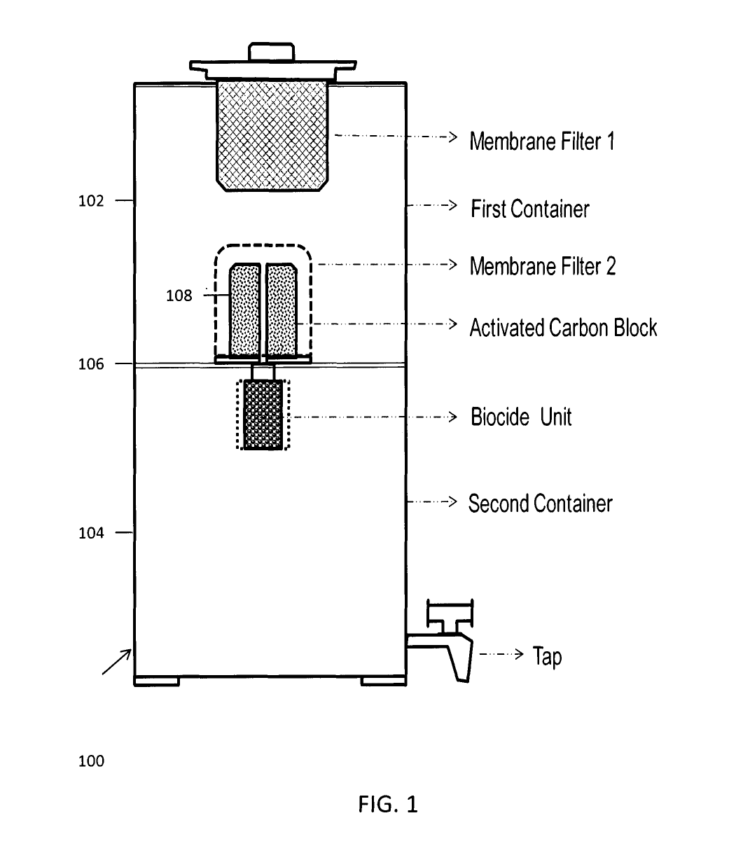

### DESCRIPTION

The present invention can be understood more readily by reference to the following detailed description of the invention and the examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

### DEFINITIONS

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a metal” includes mixtures of two or more metals.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or cannot occur, and that the description includes instances where said event or circumstance occurs and instances where it does not.

As used herein “unpurified water” and the like terms refer to water that has not been purified with the systems described herein. For example, unpurified water can be contaminated water.

In one aspect, the gravity-fed storage water purifier of the present invention can utilize the following pre-requisites: (i) biocidal composition having one or more of fast kinetics for adsorption of contaminants, fast kinetics for desorption of biocide into water and fast electron transfer from the adsorbent surface to contaminant molecules that may be present; and (ii) in case of release of any active ingredient from the adsorbent composition, the concentration should be within the WHO limits for safe drinking water, thereby preventing the need to provide a second stage purification unit.

The gravity-fed storage water purifier of the present invention comprises a membrane cloth having a first layer and a second layer. In one aspect, a granular biocidal composition is disposed between the first and second layers. The membrane cloth removes dirt, sand and sediments from unpurified water, such as contaminated water, using a depth filtration mechanism. The granular biocidal composition can destroy bacteria and viruses from drinking water by leaching silver ions into water and by the adsorption of viruses on organic templated boehmite nanoarchitecture or chemical interaction with the leached silver ions. Illustrative biocidal compositions are described in our previous Indian patent applications 947/CHE/2011 and 20070608 by T. Pradeep et al., entire contents of which are herein incorporated by reference.

In one aspect, use of the water purifier can require manual pouring of water, such as contaminated water, onto the membrane cloth layer, at a typical flow rate of 1-2 liters/min. In one aspect, the flow rate can be 0.1-5 liters/min. The passing water can contact the granular biocidal composition, wherein silver ions can be leached from the biocidal composition into the water. After passing through the membrane cloth layers and biocidal composition, the water can then be collected in a storage container. The storage container can have a capacity of 5-30 liters, such as 10 liter or 15 liters. A typical time of 5-10 minutes is required to fill the storage container. The water can stay in the storage container for up to one hour, for removing microorganisms as per the United States Environmental Protection Agency (US EPA) drinking water norms. The duration of one hour is controlled by a device fitted at an outlet tap. The device can work on the principle of a time-dependent released stopper, wherein the knob provided on the device is rotated to a position marked with one hour release time. After an hour, the release mechanism is activated and the outlet tap can be opened. Therefore the water at the outlet tap is safe for consumption.

The advantages of the gravity-fed storage water purifier are as follows: (i) Purchase cost for the water purifier is reduced due to the use of only a single container. (ii) Since the residual silver ion concentration in water is below or well below WHO limits, there is no requirement for further purification of water. (iii) The effective duration for each cycle of water purification is enormously improved, thereby facilitating faster availability of purified drinking water to the consumer.

It is also known from the prior art that technologies utilized for the purification of drinking water require a reasonable contact time (Advances in water treatment by adsorption technology, Ali et al., Nature Protocols, 2006, 1(6), 2661). In the case of activated carbon, adsorption of contaminants can require an empty bed contact time (EBCT) of 10 minutes (Predicting GAC performance with rapid small-scale column test, Crittenden et al., J. Am. Water Works Assoc. 1991, 83, 77-87). The removal of chlorine by activated carbon is usually fast because it is a redox reaction between activated carbon and chlorine and therefore it is not an adsorption process (Reduction of aqueous free chlorine with granular activated carbon—pH and temperature effects, Suidan et al., Environ. Sci. Technol., 1977, 11 (8), 785-789). Similarly, silver impregnated activated carbon has been used for the removal of bacteria from drinking water at EBCT of 30 seconds (Silver-embedded granular activated carbon as an antibacterial medium for water purification, Bandyopadhyaya et al., J. Chem. Technol. Biotechnol., 2008, 83, 1177-1180). It has been reported by Bridges et al. in PCT published application 2008/106276 that chlorine and bromine based disinfection media require a contact time of 1-3 seconds for microbial killing.

The active biocide usually leaches from the biocide composition in the passing water and the water containing the active biocide is maintained for a definite time. Typically, the killing of microorganisms can be accomplished in two ways: lower time with a high dose or higher time with a low dose. The second way is advantageous as the necessity of an additional filtration step to remove excess biocide from water is prevented. A standing time of over 30 minutes has been used and implemented for chlorine based disinfection media by Mistry et al. in PCT published application PCT published application 2004/000732.

To utilize a composition for drinking water purification by packing it in the membrane cloth, an EBCT of 0.1 second is made available for the contact between the composition and water. We hereby report the design of a water purification device based on a composition based on silver nanoparticles impregnated organic template boehmite nanoarchitecture (Ag-OTBN) for water purification. The method of preparation and its use for water purification is detailed in our previous patent application 947/CHE/2011, which is incorporated herein by reference. While not wishing to be bound by theory, the mechanism for biocidal activity of silver nanoparticles is believed due to the release of silver ions in water. This mechanism of silver ion release has been previously utilized for the biocidal action. In case of Ag-OTBN, a constant release of silver ions in water over a volume capacity of 1,500 liters has been previously demonstrated. The silver ion concentration in water is typically around 20 ppb and is well below 100 ppb limit as prescribed by WHO for safe drinking water.

To eliminate the use of two containers, it is necessary to store the purified water in one container and eliminate the need of storing unpurified water, such as contaminated water, in another container. In such an aspect, unpurified water, such as contaminated water, is in contact with the biocide composition at the inlet of container used for the storage of purified water. Preferably, the biocide composition is packed in-between two layers of a membrane cloth.

However, a critical constraint with the use of biocide composition in the membrane cloth is that the contact between the biocide composition and the unpurified water, such as contaminated water, is minimal. As an illustrative example, 20×60 mesh Ag-OTBN granules can be sandwiched between two layers of membrane cloth. The dimensions of such a cylindrical filtration unit are 10 cm (D)×10 cm (H), wherein the Ag-OTBN occupies 1 cm depth. For a typical flow rate of 1 L/min, an EBCT is calculated to be 0.1 second. In general, in an online water purifier, EBCT of 2-5 seconds is practiced.

The second aspect of an effective biocidal action is the standing time provided to the water when the leached biocide is present in the water. This is true of practically all the biocides known for use in drinking water purification. This has been reported in several previous reports (Mistry et al. in PCT published application PCT published application 2004/000732; Antibacterial Activity and Mechanism of Action of the Silver Ion in Staphylococcus aureus and Escherichia coli, Jung et al., Appl Environ Microbiol., 2008, 74(7), 2171; Observations on Halogens as Bathing Water Disinfectants, Brown et al., J. Appl Microbiol, 1966, 29, 3, 559). With the use of higher biocide concentrations in water, less standing time is required and vice-versa. However, using higher concentration of biocide can be disadvantageous because: (i) concentration in excess of allowed limits for drinking water requires an additional step for biocide removal and (ii) excess biocide concentration may also lead to redox and/or other reactions with organic load usually found in drinking water.

There are several ways by which standing time can be implemented, primarily depending on the duration of standing time required and complexity of water purifier design: (i) a simple notification on the product for the consumer, stating that a fixed standing time is necessary for complete microbial killing, (ii) a travel path implemented for water, wherein water moves slowly inside the water purifier prior to reaching the output water container, (iii) a device fitted at the outlet tap to block the water flow, wherein the user switches on the device upon filling the container with water and the device takes a fixed time to open the blockage in the water flow through the tap and (iv) a device located in the water purifier which is activated by the water pressure and deactivated after a predetermined period of time (the device may or may not be integrated as a blockage to water flow through the tap). In the particular case of this invention, an analog device is fitted prior to the outlet tap, for controlling the standing time of water in the container. A general construction of a device is based on a mechanical clock, for example, comprising an oscillator and a controller device, wherein an oscillator (typically made of pendulum or mechanical wheel) vibrates/oscillates repetitively at a pre-determined frequency. Such an oscillator can be powered by a spring or a weight suspended from a cord wrapped around a pulley. The forward movement of the mechanical clock is made by the movement of a gear tooth of the escape wheel at each swing. Similar designs in use for wind-up mechanical alarm can be accessed commercially.

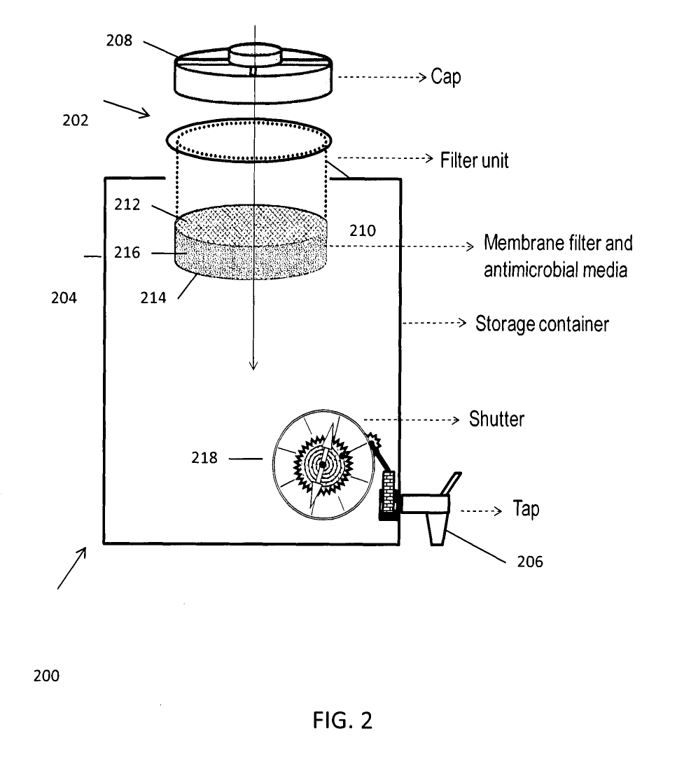

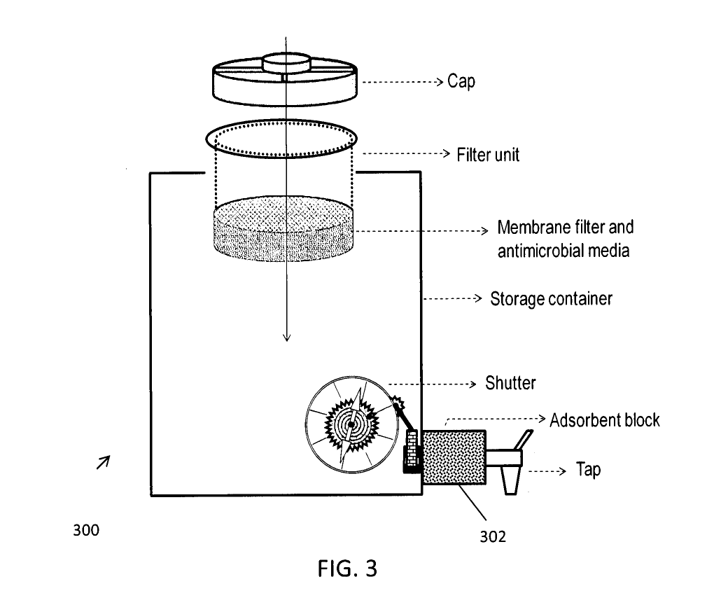

FIG. 2 depicts a single container gravity-fed storage water purifier 200, in accordance with an embodiment of the present invention. The single container gravity-fed storage water purifier 200 includes a filtration unit 202, a storage container 204 and an outlet tap 206. The critical component of the single container gravity-fed storage water purifier 200 is the filtration unit 202, which is fitted at the top of the storage container 204. The filtration unit 202 can include a cap 208 that is used to close the entry of water when the purifier is not in use. In one aspect, the cap 208 is detachable. The cap 208 can also include a provision for direct connection to an external tap supply (shown and described in FIG. 3). The filtration unit 202 also includes a housing 210 that holds the unpurified water, such as contaminated water, for driving the water through filtration unit 202. Since the granular composition packed in the filtration unit 202 offers negligible pressure drop, the housing 210 can be of minimum height. In one aspect, the housing 210 is detachable and therefore, easily washable by a user.

The bottom of the filtration unit 202 is provided with two membrane cloth layers—a first membrane cloth layer 212 and a second membrane cloth layer 214. In one aspect, the first and second membrane cloth layers 212 and 214 are of same filtration efficiency (expressed either in terms of micron rating of the cloth or the mass of the cloth per square meter). A granular biocidal composition layer 216 is disposed uniformly between the first and second membrane cloth layers 212 and 214. In one aspect of the present invention, the granular biocidal composition layer includes granules of Ag-OTBN. The granular size of the Ag-OTBN particles is in the range of 0.3 mm to 5 mm. In a preferred aspect, the size of the granules is in the range of about 0.5 mm to about 1.0 mm. Upon passing through the first membrane cloth layer 212, the water contacts the granular biocidal composition, wherein silver leaches into the water in the ionic form. The leached silver ions in the water lead to killing of any microorganisms contained therein. The tap 206 facilitates the process of obtaining the stored filtered water from the storage container 204.

In one aspect, the water is maintained in the storage container 204 for at least about one hour. The duration of one hour is regulated by a control device 218 fitted at the outlet tap 206. Such control devices 218 are generally known in the art, and can work on the principle of the time-dependent release of a stopper. The knob provided on the control device 218 can be rotated to a position marked with one hour release time. After an hour, the release mechanism can be activated and the outlet tap 206 can be opened. Therefore the water at the outlet tap is always safe for consumption.

It will be apparent to a skilled artisan that in designing water purification devices, the placement of biocidal composition in the filtration unit 202 of the single container gravity-fed storage water purifier 200 can be subjected to various modifications, without significantly altering the performance or scope or spirit of the present invention. In one aspect, granular adsorbent is used for the removal of various other contaminants from drinking water. The granular may include activated carbon, activated alumina, silica, titania, ion exchange resin, halogenated resin and combinations thereof.

FIG. 3 depicts a single container gravity-fed storage water purifier 300, in accordance with another aspect of the present invention. It should be noted that the single container gravity-fed storage water purifier 300 is similar in construction as the single container gravity-fed storage water purifier 200 of FIG. 2. In addition, a porous adsorbent block 302 may be fitted between the tap 206 and the storage container 204.

In one aspect, the porous adsorbent block 302 comprises carbon. With reference to our previous patent application 2892/CHE/2010 (entire contents of which are herein incorporated by reference), it should be noted that at a pressure head of 0.5 psi (usually available in gravity-fed storage water purifiers) and a flow rate of 500-600 ml/min is feasible through a porous carbon block (for a path length of 5.5 cm). The use of activated carbon porous block 302 at the outlet tap 206 ensures that even organic impurities are removed. Due to reasonably high flow rate through the porous carbon block 302, the user will not face difficulty in collecting the water through the tap. Another advantage of using the porous carbon block 302 at the output tap is that as bacteria free water passes through the carbon block, no bacteria breeding takes place inside the porous carbon block 302. It has been previously reported that activated carbon block is known to act as a breeding ground for bacteria, and therefore, the challenge of preventing bio-growth is automatically solved. Instead of activated carbon, other adsorbent media can be used to remove specific or a range of contaminants such as fluoride, mercury, arsenic, etc.

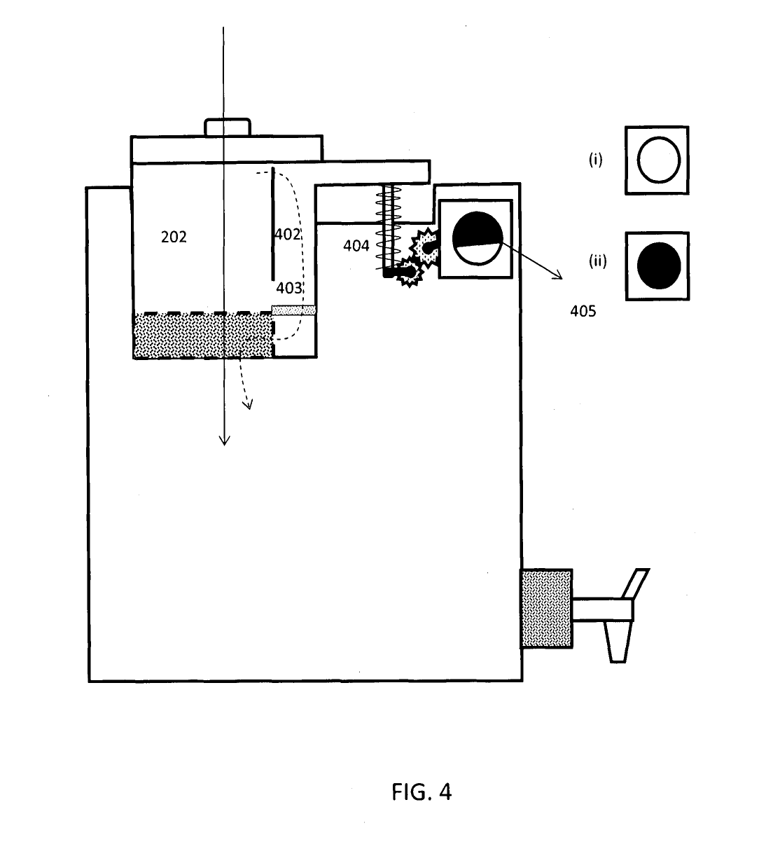

FIG. 4 depicts a container water purifier with an alternative time indicator. A filtration unit 202 can be located on a movable mechanical spring 404 which is connected to and controls an indicator color shutter 405. The weight of the filtration unit 202 when filled with water is transferred to the mechanical spring 404, thereby compressing the mechanical spring 404 and allowing the indicator color shutter 405 to move from its initial position. The mechanical spring 404 takes one hour to return to the initial position. This change in position of the mechanical spring 404 is indicated by a change in the color of indicator color shutter 405. Further, a chamber 402 with a porous block 403 at the bottom is created inside the filtration unit 202. The chamber 402 can hold a quantity of 50 to 100 mL of water when it is filled and takes one hour to drain through the porous block 403 thereby providing the mechanical spring 404 with one hour time control period. The quantity of water in the chamber 402 determines the weight of the filtration unit 202 that is transferred to the mechanical spring 404. FIG. 4(i) is a status of indicator color shutter 405 depicting completion of the one hour time control period thereby indicating that the water is ready to be consumed. FIG. 4(ii) is a status of indicator color shutter 405 indicating that the one hour time control period is under progress and the water is not yet ready to be consumed. It should be understood by a person skilled in the art that the variants of the embodiments described above in conjunction with FIG. 4 can also be used for designing a fully functional water purifier with time indicator.

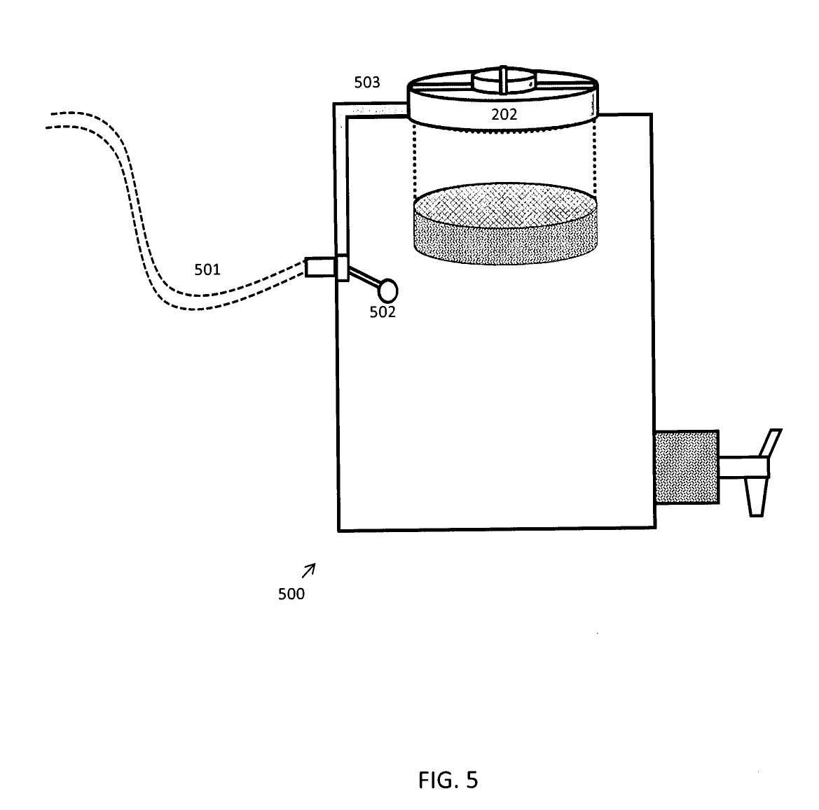

FIG. 5 depicts a single container gravity-fed storage water purifier 500, in accordance with yet another aspect of the present invention. The single container gravity-fed storage water purifier 500 is similar in construction to the single container gravity-fed storage water purifier 200. In addition, an accessory comprising a piped water supply 501, a float valve 502 and a pipe connection 503 is integrated with a water purifier 500. The piped water supply 501 is connected to the water purifier 500 and extends to the filtration unit 202 through a pipe connection 503. The pipe connection 503 is connected with the filtration unit 202 through a leak-proof assembly (not shown). A float valve 502 is provided at a junction of piped water supply 501 and pipe connection 503. The float valve 502 closes when the water level in the water purifier 500 reaches a predetermined level resulting in obstructing water flow to pipe connection 503 and the filtration unit 202. When the water level in the water purifier 500 goes below the predetermined level, the float level 502 opens and initiates water flow through the pipe connection 503 and the filtration unit 202.

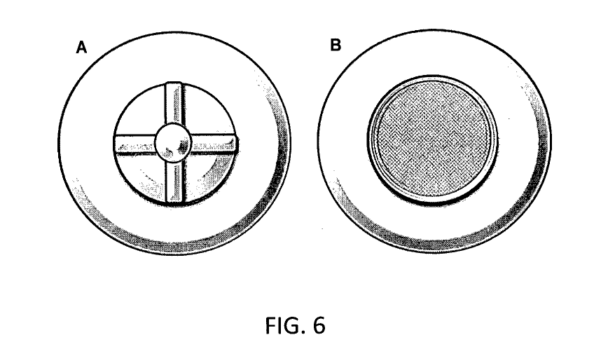

FIG. 6 depicts top views of a single container gravity-fed storage water purifier with and without a cap (views A and B respectively), in accordance with various aspects of the present invention.

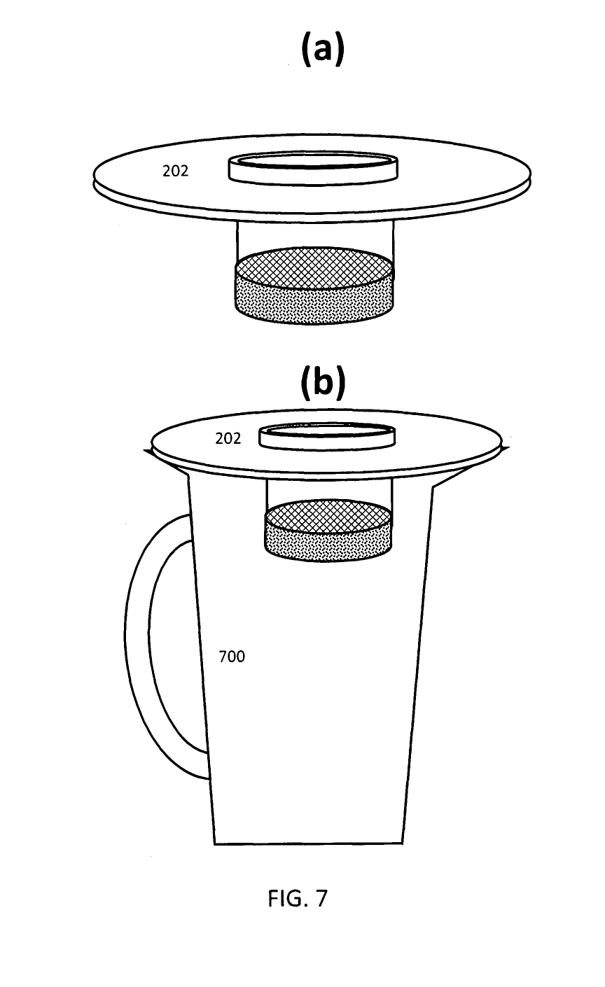

FIG. 7(a) depicts the filtration unit 202 as a stand-alone water purification unit in accordance with an aspect of the present invention. The filtration unit 202 is integrated with a storage container of any type, shape, size, capacity or make. FIG. 7(b) depicts the filtration unit 202 integrated with a carafe 700 as the storage container. The storage container may be one of a bottle, can, bucket, drum, carafe, jug, box, tumbler, pitcher, canister, pot, and tank or like. The performance efficacy of the filtration unit 202 is independent of the nature of the storage container and it can be used repeatedly for a number of cycles.

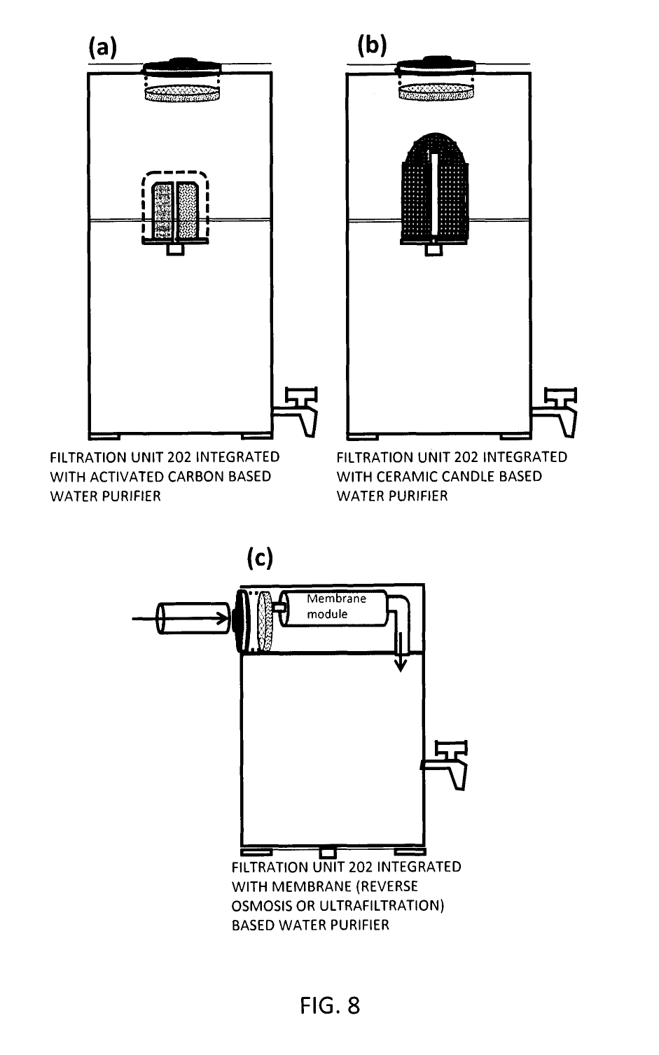

FIG. 8 depicts filtration unit 202 integrated with a number of commercially available water purifiers in the market, in accordance with various aspects of the present invention. In general, a water purifier consists of a pre-filter that provides pre-filtered water that is still contaminated with microorganisms, to a subsequent filtration module. The water contaminated with microorganisms causes bio-fouling in the filtration module.

Therefore the pre-filter is replaced or combined with the filtration unit 202, such that water that enters the filtration module remains disinfected. Examples of integrating filtration unit 202 with an activated carbon based water purifier (FIG. 8a), ceramic candle based water purifier (FIG. 8b) and membrane based water purifier (FIG. 8c) are shown. It is to be noted that an advantage of using filtration unit 202 with other water purifiers is that EBCT of filtration unit 202 is extremely low; hence, it doesn't offer any further pressure drop in pre- or post-integration with other filtration media. Therefore, filtration unit 202 may also be placed just after the other filtration media, if required. For example, the filtration unit 202 may be post-integrated with activated carbon based filter in FIG. 8a, leading to a new design of water purifier.

It will be apparent to a skilled artisan that in designing water purification devices, the placement of a time indicator can be subjected to various modifications, without significantly altering the performance or scope or spirit of the present invention. In one aspect, a time indicator is integrated with the filtration unit, in which case it may be used as a stand-alone water purification unit. In another aspect, a time indicator is integrated with the storage container. In another aspect, a time indicator is integrated with adsorbent composition.

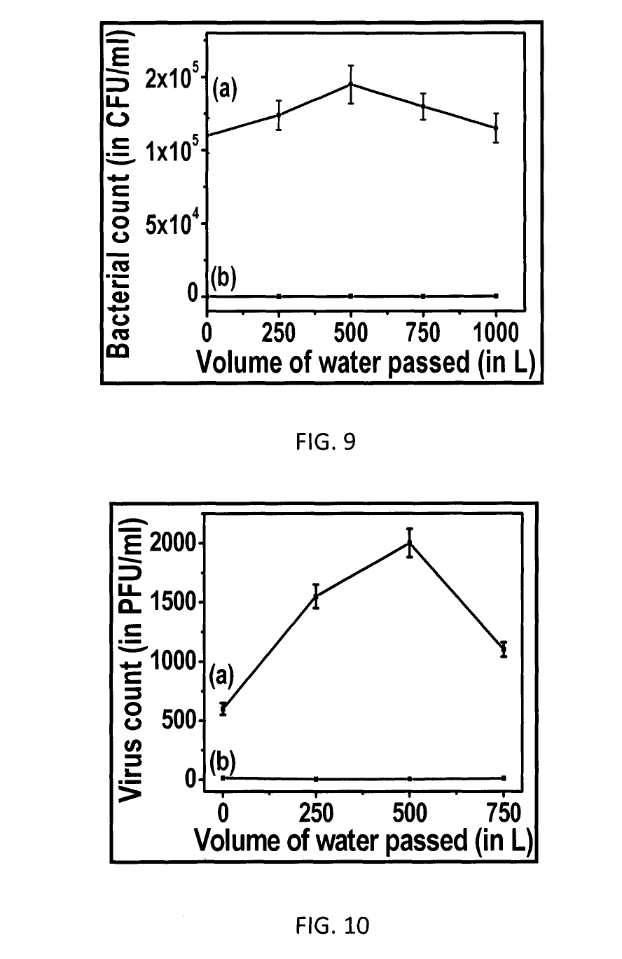

Referring now to FIG. 9, a graph depicting a plot between volume of water passed through the gravity-fed storage water purifier 300 and corresponding bacterial count, in accordance with various aspects of the present invention, is shown. It can be observed from the graph that the performance of the water purifier is intact over the passage of a volume over ˜750 liters (challenge water concentration for E. coli: 1×10⁵ CFU/ml). Traces (a) and (b) denote input and output, respectively. Error bar shown in trace (a) is due to the daily variation in the bacterial concentration.

FIG. 10 depicts a plot between volume of water passed through the gravity-fed storage water purifier 300 and corresponding virus count, in accordance with various aspects of the present invention. As can be seen from FIG. 10, the performance of the water purifier is intact over the passage of a volume of over ˜750 liters (challenge water concentration for MS2 coliphage: 1×10³ PFU/ml). Traces (a) and (b) are for input and output, respectively.

The described aspects are illustrative of the invention and not restrictive. It is therefore obvious that any modifications described in this invention, employing the principles of this invention without departing from its spirit or essential characteristics, still fall within the scope of the invention. Consequently, modifications of design, methods, structure, sequence, materials and the like would be apparent to those skilled in the art, yet still fall within the scope of the invention.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A gravity-fed storage water purifier, comprising:
a filtration unit for receiving unpurified water, the filtration unit comprising:
a housing unit;
a first membrane cloth layer;
a second membrane cloth layer; and
a granular biocidal composition layer disposed between the first and second membrane cloth layers; and
a storage container, whereby the unpurified water is filtered by virtue of the first and second membrane cloth layers, the granular biocidal composition layer, and gravity, and whereby the filtered water is stored in the storage container.

2. The gravity-fed storage water purifier of claim 1, wherein the granular biocidal composition layer comprises silver nanoparticles impregnated on organic templated boehmite nanoarchitecture.

3. The gravity-fed storage water purifier of claim 1, wherein the granular biocidal composition layer comprises silver nanoparticles impregnated on silver nanoparticles impregnated on polyurethane.

4. The gravity-fed storage water purifier of claim 1, wherein the granular biocidal composition layer comprises silver nanoparticles impregnated on at least one of an oxide and an oxyhydroxide of at least one of aluminum, zinc, manganese, iron, titanium, zirconium, lanthanum, cerium, and silicon.

5. The gravity-fed storage water purifier of claim 1, wherein the granular biocidal composition layer comprises silver nanoparticles impregnated on silver nanoparticles impregnated on activated carbon.

6. The gravity-fed storage water purifier of claim 1, wherein the first and second membrane cloth layers are one or more of detachable, washable, attachable, or a combination thereof.

7. The gravity-fed storage water purifier of claim 1, wherein a size of granules of the granular biocidal composition layer is about 0.3 mm to about 1.5 mm.

8. The gravity-fed storage water purifier of claim 1, wherein a size of granules of the granular biocidal composition layer is about 0.5 mm to about 1 mm.

9. The gravity-fed storage water purifier of claim 1, wherein the unpurified water is poured through the filtration unit at a flow rate of about 0.5 L/min to about 5 L/min.

10. The gravity-fed storage water purifier of claim 1, wherein the unpurified water is poured through the filtration unit at a flow rate of about 1 L/min to about 2 L/min.

11. The gravity-fed storage water purifier of claim 1, wherein the filtration unit comprises a water inlet connected to a supply of water.

12. The gravity-fed storage water purifier of claim 1 further comprising an outlet tap attached to the storage container for outputting the filtered water.

13. The gravity-fed storage water purifier of claim 12 further comprising an alarm mechanism, wherein the alarm mechanism is configured to be set for retaining the filtered water in the storage container for a predetermined period of time, before it is outputted by way of the outlet tap.

14. The gravity-fed storage water purifier of claim 12 further comprising an adsorbent composition disposed between the storage container and the outlet tap.

15. The gravity-fed storage water purifier of claim 12, wherein the adsorbent composition comprises at least one of an activated carbon, an activated alumina, a silica, a titania, an ion exchange resin, and a halogenated resin.

16. The gravity-fed storage water purifier of claim 1, wherein the storage container is made of at least one of an engineering plastic, stainless steel, copper, brass, and an earthenware.

17. The gravity-fed storage water purifier of claim 1, wherein the first and second membrane cloth layers are made of at least one of a cellulose, a polyester, a nylon, and a polypropylene.

18. The gravity-fed storage water purifier of claim 1, wherein the water purifier further comprises a float valve that regulates flow of water to the water purifier.

19. The gravity-fed storage water purifier of claim 1, wherein the water purifier is connected to a piped water supply to supply water to the water purifier.

20. The gravity-fed storage water purifier of claim 1, wherein the filtration unit is used as a water filtration unit for collecting the filtered water in a container.

21. The gravity-fed storage water purifier of claim 18, wherein an alarm mechanism is integrated with the filtration unit.

22. The gravity-fed storage water purifier of claim 18, wherein the container comprises a bottle, can, bucket, drum, carafe, jug, box, tumbler, pitcher, canister, pot, or a combination thereof.

23. The gravity-fed storage water purifier of claim 18, wherein the filtration unit can be integrated with a commercially available water purifier.

24. A gravity-fed storage water purifier, comprising:
a filtration unit for receiving water, the filtration unit comprising:
a housing unit;
a first membrane cloth layer;
a second membrane cloth layer; and
a granular biocidal composition layer disposed between the first and second membrane cloth layers;
a storage container, whereby the water is filtered by virtue of the first and second membrane cloth layers, the granular biocidal composition layer, and gravity, and whereby the filtered water is stored in the storage container;
an adsorbent composition; and
an outlet tap attached to the storage container, wherein the stored filtered water is output by way of the adsorption composition and through the outlet tap.
